(19) United States
(12) Patent Application Publication
(10) Pub. No.: US 2022/0322608 A1
(43) Pub. Date: Oct. 13, 2022

(54) METHOD OF CONVERTING A CAGED INTERMEDIATE BULK CONTAINER TO A STACKABLE PLANT MATERIAL DRYER

(71) Applicant: Odin Consulting LLC, Watsonville, CA (US)

(72) Inventor: Odin DEMOS, Watsonville, CA (US)

(73) Assignee: Odin Consulting LLC, Watsonville, CA (US)

(21) Appl. No.: 17/465,765

(22) Filed: Sep. 2, 2021

Related U.S. Application Data
(60) Provisional application No. 63/173,882, filed on Apr. 12, 2021.

(51) Int. Cl. A01F 25/12; F26B 25/18; B21F 15/10; B65D 88/02; B65D 19/02

(52) U.S. Cl. CPC A01F 25/12; F26B 25/185; B21F 15/10; B65D 88/022; B65D 19/02; F26B 2200/02; F26B 9/10

(57) ABSTRACT

A method of manufacturing a dryer for plant material, which converts a caged intermediate bulk container tote into a dryer by adding wires from which plant material may be hung to dry. Intermediate bulk containers (IBCs) are widely available and offer the benefits of stackability and easy transport; the method creates plant material dryers with the same advantages. Any number of wire segments may be attached to the cage of the IBC tote. Illustrative configurations may place wires into two rows: one row of wires across the top of the cage, and a second row roughly at mid-height of the cage. Wires may be for example stainless steel wires with a gauge between 24 gauge and 30 gauge.

This application claims priority to U.S. provisional patent application No. 63/173,882, filed 12 Apr. 2021, the specification of which is hereby incorporated herein by reference.

### BACKGROUND OF THE INVENTION

### Field Of The Invention

One or more embodiments of the invention are related to the field of manufacturing methods to produce processing equipment for plant-based products. More particularly, but not by way of limitation, one or more embodiments of the invention enable a method of converting a caged intermediate bulk container tote to a stackable plant material dryer.

### Description Of The Related Art

The Agricultural Industry, including farmers, wholesalers and packagers and distributors send to the retail or wholesale market a large number and quantity of biomass/produce products that must be dried prior to transport, either because the product, as sold to retailer customers is sold is a dried or partially dried form (rather than in the condition which it is immediately harvested), because drying is necessary to prevent spoilage during storage, transport or packaging, or because the biomass is to be used as an ingredient in another product for which it is needed in a dried form. Examples include dried flowers, tobacco, sun-dried tomatoes, tea leaves, raisins, prunes, dried fruits, etc.

The process of drying of agricultural products prior to their release to market creates significant costs for producers because it can take up significant amounts of space, be difficult to store and sort and, if done incorrectly, lead to loss of product to spoilage or infestation of pests, mold, etc. which can render the products un-sellable.

Specialized equipment for drying plant-based products is known in the art. An illustrative drying rack is described for example in United States Utility Patent Application Publication No. 2019/0297781. A limitation of this and other existing systems is that they are relatively expensive because they are specifically constructed for each drying application. Another limitation is that these systems are often not space-efficient; in particular, they are not easily stacked vertically. They also cannot be transported easily using standard equipment such as forklifts.

For at least the limitations described above there is a need for a method of converting a caged intermediate bulk container tote to a stackable plant material dryer.

### BRIEF SUMMARY OF THE INVENTION

One or more embodiments described in the specification are related to a method of converting a caged intermediate bulk container tote to a stackable plant material dryer. Embodiments of the invention may construct a dryer from an intermediate bulk container (IBC), resulting in a dryer that is stackable and easily transportable. Using a converted IBC for drying allows the dried or drying material to be easily moved using standardized equipment such as forklifts. The converted IBC dryers can be stacked, optimizing use of available space. The converted IBC totes provide for compartmentalization of drying, allowing products to be neatly sorted and organized without mixing of different products or products from different sources. The modularity of the system provides for a scalable drying operation; capacity can be increased simply by adding more converted IBC totes.

One or more embodiments may include the steps of obtaining a caged intermediate bulk container tote, obtaining a plurality of wire segments, and attaching each of the wire segments to the cage. The tote may have a lattice of cage bars surrounding an open tote interior. Associated with the lattice is a vertical axis that points upward when the tote is upright and level, a top plane perpendicular to the vertical axis (i.e., horizontal) lying at or near the top of the lattice, and a middle plane parallel to the top plane lying vertically below the top plane. Each wire segment may have a first end section, a second end section, and a hanger section between the first end and second end sections. Each wire segment may be attached to the cage by attaching the first end to a corresponding location on the lattice of cage bars and attaching the second end to another corresponding location on the lattice of cage bars; the hanger section of the wire segment lies in the open tote interior after attachment.

One or more embodiments may further include stacking the stackable plant material dryer vertically with one or more other stackable plant material dryers.

In one or more embodiments, the hanger sections of the wires may be substantially horizontal (parallel to the top plane) after the wires are attached to the cage.

In one or more embodiments, wire segments may be attached to the cage by wrapping each end section around one or more bars of the lattice of cage bars.

In one or more embodiments, the wire segments may be stainless steel; they may for example have a gauge between 24 gauge and 30 gauge, inclusive.

In one or more embodiments the IBC tote may be a 275-gallon caged IBC tote.

In one or more embodiments the plurality of wire segments may include a plurality of top wire segments and a plurality of middle wire segments. The top wire segments may be attached so that their hanger sections are in or near the top plane, and the middle wire segments may be attached so that their hanger sections are in or near the middle plane. The middle plane in one or more embodiments may lie approximately halfway between the top of the cage bar lattice and the bottom of the cage bar lattice.

In one or more embodiments the plurality of top wire segments may have four top wire segments, and the plurality of middle wire segments may have three or four middle wire segments.

In one or more embodiments the plurality of top wire segments may have three top wire segments, and the plurality of middle wire segments may have five or six middle wire segments.

### BRIEF DESCRIPTION OF THE DRAWINGS

The above and other aspects, features and advantages of the invention will be more apparent from the following more particular description thereof, presented in conjunction with the following drawings wherein:

FIG. 1 shows a flowchart of illustrative steps of one or more embodiments of the invention.

FIG. 2 shows inputs and the output of an illustrative embodiment of the invention that constructs a plant drying apparatus from an intermediate bulk container and wire.

FIG. 3 shows a view of the drying apparatus of FIG. 2 that illustrates the location and orientation of wires in an illustrative embodiment.

FIG. 4 shows illustrative plant material hanging from one of the wires of the drying apparatus of FIG. 3, and it shows a closeup view of the wire wrapping around a cage bar.

FIG. 5 shows a variation of a drying apparatus generated by one or more embodiments of the invention; this apparatus has three upper wires and five middle wires.

FIGS. 6 illustrates the step of stacking drying apparatus vertically.

### DETAILED DESCRIPTION OF THE INVENTION

A method of converting a caged intermediate bulk container tote to a stackable plant material dryer will now be described. In the following exemplary description, numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

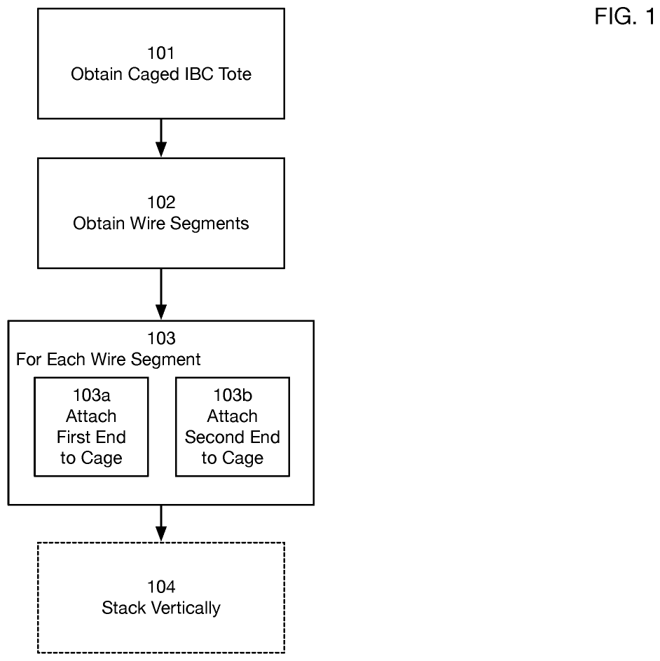

In one or more embodiments of the invention, a caged IBC (intermediate bulk container) tote is converted into a plant material dryer. FIG. 1 shows illustrative steps that may be used to effect this conversion. In step 101, a caged IBC tote is obtained. Caged IBC totes are widely available and are used extensively in the logistics industry. They generally have a metal outer cage and a plastic interior storage reservoir/tank typically used for the storage of bulk quantities of liquids, typically between 500 and 3000 liters. 275-gallon totes are the most common size, and this size may be used in one or more embodiments of the invention.

The plastic bladder of the IBC tote is not however connected to the cage but rather is shaped to fit within it and to be inserted separately. The caged IBC tote obtained in step 101 includes the outer cage but excludes the interior plastic reservoir. (Caged totes without an interior bladder are available in the industry; alternatively, if an IBC tote is obtained that includes an interior bladder, the bladder may be removed as part of step 101.) The cage is often a cubical or rectangular shape, and it is made of a lattice of cage bars. The IBC cages are a standardized size, with the base sized to match the dimensions of a standard pallet, and comprises of four sides and a support, which allows it to perform the functions of a pallet, including being moveable by a standard forklift and stackable. The top of the cage is open. Since the bladder is not present, the interior of the cage is open after step 101.

In step 102, wire segments are obtained. These wire segments may support hanging plant material for drying. Any type or types of wire or similar material may be used. Illustrative wire that may be used in one or more embodiments may be for example, without limitation, stainless steel wire with a gauge between 24 gauge and 30 gauge, inclusive.

In step 103, each of the wire segments is attached to bars of the cage. In step 103a, the first end of each segment is attached to a first location on the cage, and in step 103b, the second end of each segment is attached to a second location on the cage. The middle section of the wire between the ends extends into the open interior of the cage, so that plant material may be hung from this middle “hanger” section. Wire segments may be attached to any locations on the cage. Any number of wire segments may be used in one or more embodiments. Wire segments may be attached so that the hanger (middle) section of each wire is approximately horizontal; however, it is also possible in one or more embodiments to use wire segments that are not strung horizontally. Different wire segments may be parallel; however, in one or more embodiments wire segments may cross or may form any desired pattern.

Wires may be attached to the cage using any desired method. For example, without limitation, wires may be wrapped around, tied to, crimped to, screwed to, bolted to, nailed to, glued to, stapled to, threaded through, welded to, or soldered to the cage. Each wire end may be attached to at least one cage bar, but in some embodiments one or more wires may be attached to multiple bars (for example at an intersection where vertical and horizontal bars cross). Wires may be attached to any portion of one or more cage bars; in one or more embodiments they may be attached for example at locations where bars have holes or narrower sections, or where bars cross or meet. Holes may be drilled, or other features may be added to bars to facilitate attachment. In one or more embodiments, a wire may have multiple hanger sections; for example, a wire may be strung across a cage and attached, and then continued back towards the other side of the cage at an angle to form another hanger.

In optional step 104, two or more of the caged IBC totes with attached wires may be stacked vertically. Stacking may continue to any number of levels. Stacking the totes vertically may maximize the use of available space.

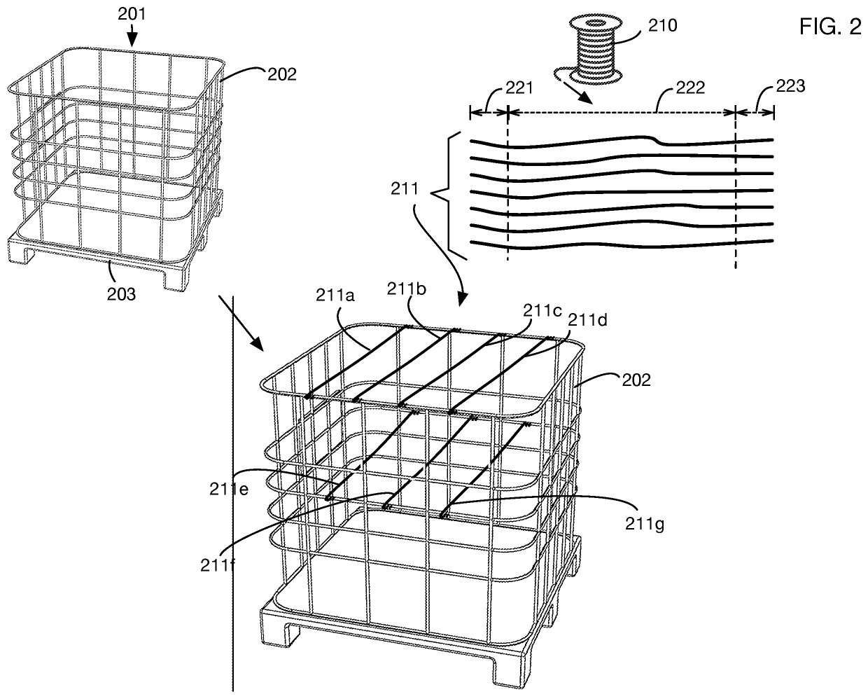

FIG. 2 shows illustrative inputs and outputs for the process steps 101 through 103 of FIG. 1. Caged IBC tote 201, which does not include an interior bladder, has lattice 202 of cage bars (vertical and horizontal), and a base 203. Wire segments 211, which may be for example cut from a wire spool 210, each have two end sections 221 and 223, and a middle hanger section 222. The wire segments 211 are attached to the bars of cage 202 to form the dryer. In this illustrative example, wires 211a, 211b, 211c, and 211d are strung across the top of the cage, and wires 211e, 211f, and 211g are strung approximately across the middle (vertically) of the cage. This configuration is illustrative; one or more embodiments may use any number of wire segments in any locations and orientations. The hanger sections of the wires after installation may be approximately horizontal in one or more embodiments, as in FIG. 2.

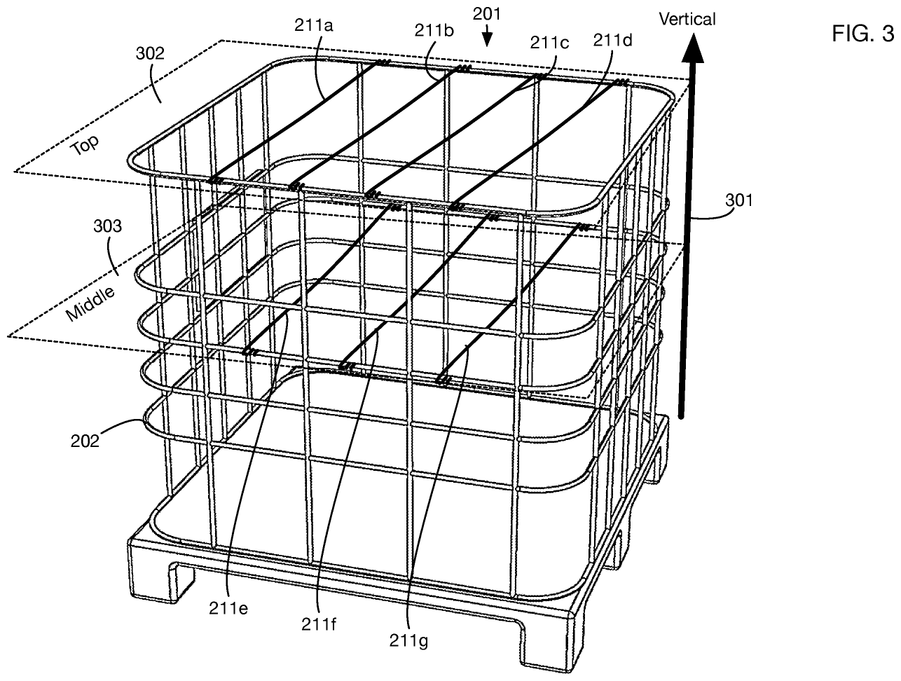

FIG. 3 shows a detailed view of the caged IBC tote 201 with wire segments 211 attached. Associated with the tote is a vertical axis 301, which points upwards when the tote is level and upright. Also associated with the tote is a top plane 302, which is perpendicular to the vertical axis 301 (i.e., horizontal), and lies approximately at the top of the cage 202. A middle plane 303 is also perpendicular to the vertical axis (i.e., horizontal), and it lies vertically approximately halfway between the top of the cage and the bottom of the cage along vertical axis 301. In the embodiment shown, the wire segments 211 are partitioned into top wires 211a, 211b, 211c, and 211d, and middle wires 211e, 211f, and 211g. The hanger portions of the top wires lie in the open interior of the cage and approximately in or near the top plane 302, and the hanger portions of the middle wires lie in the open interior of the cage and approximately in or near the middle plane 303. In one or more embodiments, the hanger sections of the wires may lie in any horizontal plane or may not be horizontal at all. A potential benefit of the configuration of FIG. 3 is that plant material of approximately the same length may be hung from the top wires and from the middle wires.

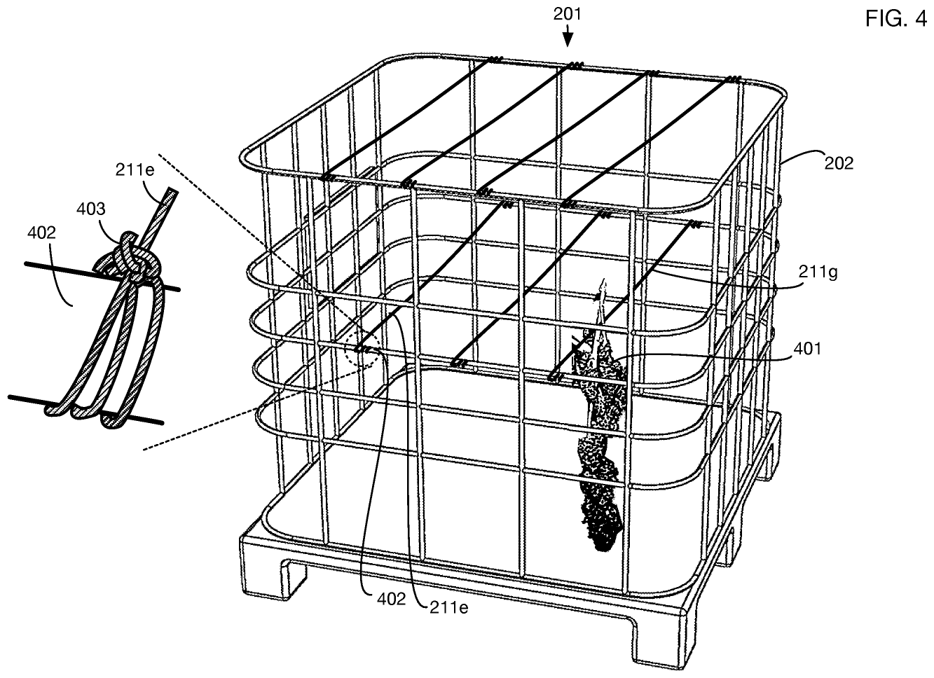

FIG. 4 shows another view of the tote 201 with the attached wire segments 211. Illustrative plant material 401 is suspended from the hanger section of wire 211g. In practice similar material may be suspended from all of the wires to fill the open interior space of the cage, while allowing enough air flow between hanging material to enable drying. Plant material may be hung directly from a wire (as shown in FIG. 4) or clipped to or otherwise attached to a wire.

FIG. 4 also shows a closeup view of the attachment of wire 211e to cage bar 402 of the cage 202. In this example wire 211e is wrapped around bar 402, and then tied with knot 403. This method of attachment is illustrative; one or more embodiments may attach wires to the cage 202 using any desired technique.

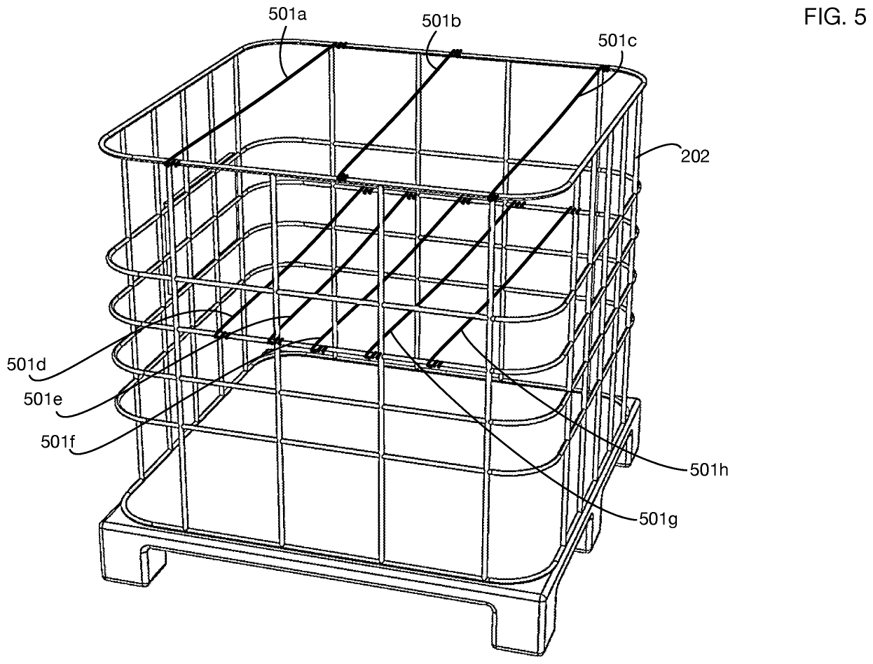

FIG. 5 shows a different wire configuration attached to cage 202. This configuration has three top wires 501a, 501b, and 501c, and five middle wires 501d, 501e, 501f, 501g, and 501h. One or more embodiments may use any number of top or middle wires, and may instead or in addition place wires in any locations and orientations. Illustrative configurations may include for example 4 top wires and 3 middle wires (as shown in FIG. 3), 4 top wires and 4 middle wires, 3 top wires and 5 middle wires (as shown in FIG. 5), and 3 top wires and 6 middle wires. Other combinations and variations may be used in one or more embodiments of the invention. Top wires and middle wires, when present, need not be parallel, although this may facilitate certain types of hanging and drying.

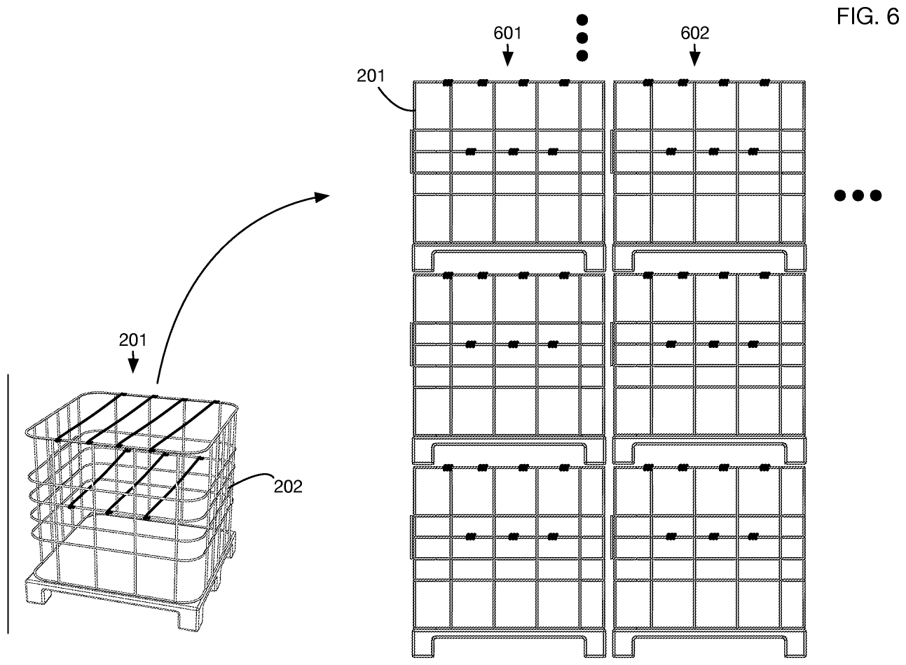

FIG. 6 illustrates step 104 of FIG. 1—vertical stacking—where caged IBC tote 201 with attached wires is placed into vertical stack 601 (shown from the side). Similar stacks 602 may be adjacent to stack 601. The totes may be vertically stacked as high as desired. All of the totes may be filled with plant material to be dried.

While the invention herein disclosed has been described by means of specific embodiments and applications thereof, numerous modifications and variations could be made thereto by those skilled in the art without departing from the scope of the invention set forth in the claims.

What is claimed is:

1. A method of converting a caged intermediate bulk container tote to a stackable plant material dryer, comprising:
obtaining a caged intermediate bulk container tote comprising a lattice of cage bars surrounding an open tote interior, wherein said caged intermediate bulk container tote comprises four sides and a support, wherein each side of said four sides comprises vertical bars of said cage bars, and wherein said lattice of cage bars is associated with
a vertical axis pointing upwards when said caged intermediate bulk container tote is upright and level;
a top plane perpendicular to said vertical axis lying at or proximal to a top of said lattice of cage bars; and
a middle plane parallel to said top plane lying vertically below said top plane;
obtaining a plurality of wire segments, wherein each wire segment of said plurality of wire segments comprises
a first end section;
a second end section; and
a hanger section between said first end section and said second end section,
wherein said hanger section extends into open air of said caged intermediate bulk container tote configured to allow plant material to hang from the hanger section between said first end section and said second end section;
for each wire segment of said plurality of wire segments,
attaching said first end section to a corresponding first end location on said lattice of cage bars;
attaching said second end section to a corresponding second end location on said lattice of cage bars different from said corresponding first end location;
wherein after said attaching said first end section and said attaching said second end section, said hanger section lies in said open tote interior in a plane perpendicular to said vertical bars;
wherein
said plurality of wire segments comprises
a plurality of top wire segments; and
a plurality of middle wire segments; and,
after said attaching said first end section and said attaching said second end section of said each wire segment,
said hanger section of each top wire segment of said plurality of top wire segments lies in the open air of the caged intermediate bulk container tote and substantially in said top plane; and,
said hanger section of each middle wire segment of said plurality of middle wire segments lies in the open air of the caged intermediate bulk container tote and substantially in said middle plane,
such that said plant material is configured to be hung from the plurality of top wire segments and from the plurality of middle wire segments while allowing enough air flow between the plant material that is hanging to enable drying;
stacking said stackable plant material dryer vertically with one or more other stackable plant material dryers that comprises attached wires.

2. (canceled)

3. (canceled)

4. The method of claim 1, wherein
attaching said first end section to said corresponding first end location comprises wrapping said first end section around at least a first bar of said lattice of cage bars at said corresponding first end location; and,
attaching said second end section to said corresponding second end location comprises wrapping said second end section around at least a second bar of said lattice of cage bars at said corresponding second end location.

5. The method of claim 1, wherein said plurality of wire segments comprise stainless steel wire.

6. The method of claim 5, wherein said stainless steel wire has a gauge in a range of 24 gauge to 30 gauge, inclusive.

7. The method of claim 1, wherein said caged intermediate bulk container tote comprises a 275-gallon caged intermediate bulk container tote.

8. (canceled)

9. The method of claim 1, wherein said middle plane lies approximately halfway between said top of said lattice of cage bars and a bottom of said lattice of cage bars.

10. The method of claim 1, wherein
said plurality of top wire segments consists of four top wire segments; and,
said plurality of middle wire segments consists of three or four middle wire segments.

11. The method of claim 1, wherein
said plurality of top wire segments consists of three top wire segments; and,
said plurality of middle wire segments consists of five or six middle wire segments.

12. A method of converting a caged intermediate bulk container tote to a stackable plant material dryer, comprising:
obtaining a caged intermediate bulk container tote comprising a lattice of cage bars surrounding an open tote interior, wherein said caged intermediate bulk container tote comprises four sides and a support, wherein each side of said four sides comprises vertical bars of said cage bars, and wherein
said lattice of cage bars is associated with
a vertical axis pointing upwards when said caged intermediate bulk container tote is upright and level;
a top plane perpendicular to said vertical axis lying at or proximal to a top of said lattice of cage bars; and
a middle plane parallel to said top plane lying approximately halfway between said top of said lattice of cage bars and a bottom of said lattice of cage bars; and
said caged intermediate bulk container tote comprises a 275-gallon caged intermediate bulk container tote;
obtaining a plurality of wire segments, wherein
each wire segment of said plurality of wire segments comprises stainless steel wire having a gauge between 24 gauge and 30 gauge, inclusive; and
each wire segment of said plurality of wire segments further comprises
a first end section;
a second end section; and
a hanger section between said first end section and said second end section,
wherein said hanger section extends into open air of said caged intermediate bulk container tote configured to allow plant material to hang from the hanger section between said first end section and said second end section; and
said plurality of wire segments consists of
four top wire segments; and,
three or four middle wire segments;
for each wire segment of said plurality of wire segments,
attaching said first end section to a corresponding first end location on said lattice of cage bars, comprising wrapping said first end section around at least a first bar of said lattice of cage bars at said corresponding first end location; and
attaching said second end section to a corresponding second end location on said lattice of cage bars different from said corresponding first end location, comprising wrapping said second end section around at least a second bar of said lattice of cage bars at said corresponding second end location;
wherein after said attaching said first end section and said attaching said second end section,
said hanger section lies in said open tote interior in a plane perpendicular to said vertical bars;
said hanger section of each top wire segment of said four top wire segments lies in the open air of the caged intermediate bulk container tote and substantially in said top plane; and
said hanger section of each middle wire segment of said three or four middle wire segments lies in the open air of the caged intermediate bulk container tote and substantially in said middle plane;
such that said plant material is configured to be hung from the plurality of top wire segments and from the plurality of middle wire segments while allowing enough air flow between the plant material that is hanging to enable drying; and,
stacking said stackable plant material dryer vertically with one or more other stackable plant material dryers that comprises attached wires.

13. The method of claim 1, wherein at least one wire segment of said each wire segment comprises multiple hanger sections, such that said at least one wire segment is strung across said intermediate bulk container tote and attached, and then continued back towards another side of the intermediate bulk container tote at an angle.

14. The method of claim 12, wherein at least one wire segment of said each wire segment comprises multiple hanger sections, such that said at least one wire segment is strung across said intermediate bulk container tote and attached, and then continued back towards another side of the intermediate bulk container tote at an angle.
